(19) United States
(12) Patent Application Publication
(10) Pub. No.: US 2025/0309592 A1
(43) Pub. Date: Oct. 2, 2025

(54) Plug Device

(71) Applicant: Anker Innovations Technology Co., Ltd., Changsha (CN)

(72) Inventors: Xu Guo, Shenzhen (CN); Songya Chen, Shenzhen (CN); Xianghuang Feng, Shenzhen (CN)

(21) Appl. No.: 19/092,060

(22) Filed: Mar. 27, 2025

(30) Foreign Application Priority Data
Mar. 29, 2024 (CN) 202420646368.4

(51) Int. Cl. H01R 24/28; H01R 13/04; H01R 103/00

(52) U.S. Cl. CPC H01R 24/28; H01R 13/04; H01R 2103/00

(57) ABSTRACT

A plug may comprise a main body and a pin assembly. A pin assembly may comprise a first pin and a second pin rotatably provided on the main body, so as to rotate between their respective storage positions and use positions relative to the main body. Rotation axes of the first pin and the second pin are parallel to each other, and a rotation direction of the first pin is opposite to a rotation direction of the second pin.

### CROSS REFERENCE TO RELATED APPLICATION

The present application claims priority to Chinese Patent Application No. 202420646368.4, entitled “Plug” filed on Mar. 29, 2024, which is incorporated herein by reference in its entirety.

### FIELD

The present disclosure relates to the technical field of charging equipment, particularly to a plug.

### BACKGROUND

Plugs are a common part of power adapters, power cords and wire extension assemblies. With the development of technology, in order to facilitate storage of plugs, a pin and a main body of some plugs are movably connected. However, when the pin of the plug is inserted into a socket, the main body can easily move relative to the pin under the action of external force, resulting in a phenomenon of “kneeling pin” (e.g., pin collapse), which negatively affects a user's experience.

### SUMMARY

The present disclosure provides a plug, which can solve a problem in the related art that when a plug is inserted into a socket, a main body of the plug can easily move relative to the pin.

In order to solve the technical problem, the present application provides: a plug comprises a main body, a first pin, and a second pin. Each of the first pin and the second pin is rotatably provided coupled to the main body between a respective storage position and a respective use position relative to the main body. Rotation axes of the first pin and the second pin are parallel to each other. A rotation direction of the first pin is opposite to a rotation direction of the second pin.

Beneficial effects of the disclosure are: Different from the related art, when the first pin and the second pin move from the use position to the storage position, the rotation directions thereof are opposite. In this case, when the main body rotates in a preset direction, one of the first pin and the second pin can be switched from the use state to the storage state, and when the main body rotates in a direction opposite to the preset direction, the other of the first pin and the second pin can be switched from the use state to the storage state. Regardless of the relative rotation of the main body in either of the above two directions, one of the pins will remain in the use state. When the first pin and the second pin of the plug are inserted and fixed into the socket, even if the main body is stressed and tends to rotate relatively toward one of the above two directions, one of the pins will remain in the use state, which restricts the main body from being stressed to rotate to a certain extent. This solves the problem that when the plug in the related art is inserted in the socket, the main body easily moves relative to the pin assembly under the action of external force, resulting in the phenomenon of “kneeling pin.”

### BRIEF DESCRIPTION OF DRAWINGS

FIG. 1 is a schematic view of a structure of a plug according to an example of the present disclosure;

FIG. 2 is a schematic view of an exploded structure of a plug according to an example of the present disclosure;

FIG. 3 is a schematic view of structures of a pin assembly and a pressing plate in FIG. 2;

FIG. 4 is a schematic view of structures of the pin assembly and a face housing in FIG. 3;

FIG. 5 is a schematic view of a structure of the pressing plate in FIG. 3 from another visual angle;

FIG. 6 is a schematic view of a structure of the pin assembly in FIG. 5 from another visual angle;

FIG. 7 is a schematic view of a structure of the face housing in FIG. 4;

FIG. 8 is a schematic view of a structure of the face housing in FIG. 7 from another visual angle; and

FIG. 9 is a schematic view of a structure of a fixing member in FIG. 7.

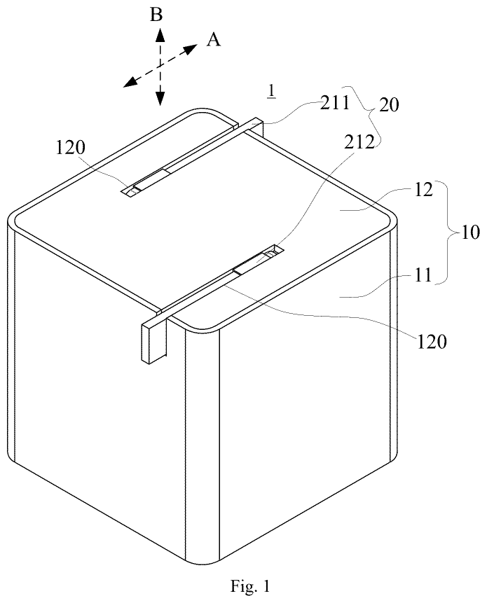

Below are all or some of the reference numbers shown in the figures. 1: plug; 10: main body; 11: main housing; 111: accommodating cavity; 112: opening; 12: face housing; 120: storage groove; 121: bottom wall; 122: side wall; 13: pressing plate; 131: elastic arm; 14: rotating shaft support; 141: groove; 15: conductive member; 151: fixing portion; 152: connecting arm; 153: first part; 154: second part; 16: fixing member; 161: first stop; 162: second stop; 163: third stop; 20: pin assembly; 211: first pin; 212: second pin; 22: linkage mechanism; 221: first gear; 222: second gear; 23: first rotating shaft; 24: second rotating shaft; 231: arc-shaped projection; 232: first limiting surface; 233: second limiting surface; 234: transitional curved surface.

### DETAILED DESCRIPTION

The technical solution of the disclosure will be described in detail below with reference to the accompanying drawings. The following examples are intended only to more clearly illustrate the technical solution of the present disclosure and are therefore intended as examples only and may not be used to limit the scope of protection of the present disclosure.

In description of the examples of the disclosure, the technical terms “first,” “second” and the like are only used for distinguishing different objects but are not to be construed as indicating or implying the relative importance or implicitly indicating the number, specific order, or primary and secondary relation of the indicated technical features. In the description of the examples of the present disclosure, “a plurality of” means two or more, unless otherwise explicitly and specifically defined.

In the description of the examples of the present disclosure, technical terms such as “mount,” “communicate,” “connect,” “fix,” and “provide,” should be understood broadly unless expressly specified or defined. For example, “connect” may refer to fixed connection, detachable connection, or integration; and may refer to direct connection or indirect connection. Specific meanings of the above terms in the examples of the present disclosure may be understood by those of ordinary skill in the art in light of specific circumstances.

Pins of some plugs can be foldable, and the working principle of such plugs is generally as follows: the pins can rotate relative to a main body of a plug, and thus a user can freely adjust a position and state of the pin as needed. However, this also means that the pin of the plug can rotate relative to the main body of the plug, resulting in a phenomenon of “kneeling pin” (e.g., pin collapse), and the pin is neither in a storage position nor in a use position relative to the main body, but at a certain angle with both the storage position and the use position. For example, when the pin of the plug is inserted into a socket on the wall, the main body may rotate under the action of gravity, resulting in the phenomenon of “kneeling pin.”

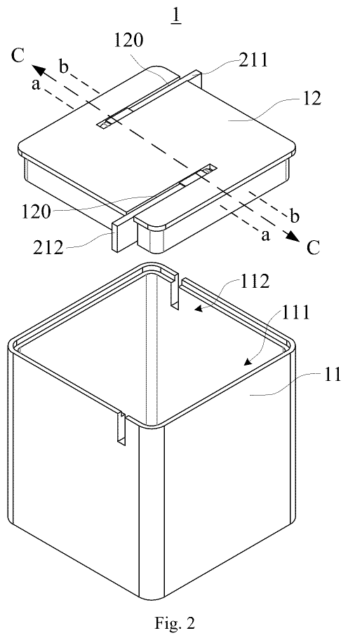

Referring to FIGS. 1 and 2, the plug 1 generally includes a main body 10 and a pin assembly 20. The main body 10 may have different structures according to the specific equipment to which the plug 1 is applied. For example, the plug 1 may be part of a charger for an electronic device (e.g., a mobile phone, an earphone, a tablet). The main body 10 may include a circuit board. The circuit board may be provided with an input circuit, an output circuit, a transformer and the like. The pin assembly 20 may be connected to a power supply line and connected to the input circuit. The output circuit is configured to output voltage. The transformer is coupled between the input circuit and the output circuit for voltage conversion.

According to an example of the present disclosure, the pin assembly 20 may include a first pin 211 and a second pin 212 provided at intervals, and the first pin 211 and the second pin 212 are rotatably provided on the main body 10 to rotate between their respective storage positions and use positions relative to the main body 10. Rotation axes of the first pin 211 and the second pin 212 are parallel to the direction in which the first pin 211 and the second pin 212 are provided at intervals, and while the first pin 211 rotates from a corresponding storage position to a corresponding use position, the second pin 212 rotates from a corresponding storage position to a corresponding use position. The first pin 211 and the second pin 212 are linked and can rotate in opposite directions.

Specifically, when the first pin 211 and the second pin 212 are both located at respective use positions, the pin assembly 20 can correspond to jacks (e.g., insertion holes) in a socket, and the first pin 211 and the second pin 212 can be inserted into the corresponding jacks. When the first pin 211 and the second pin 212 are both located at respective storage positions, the first pin 211 and the second pin 212 can be partially or fully folded in the main body 10, and a plug 1 cannot be inserted into the corresponding jacks for use. When the first pin 211 and the second pin 212 are both located at the respective storage positions, the plug 1 may be as shown in FIG. 1.

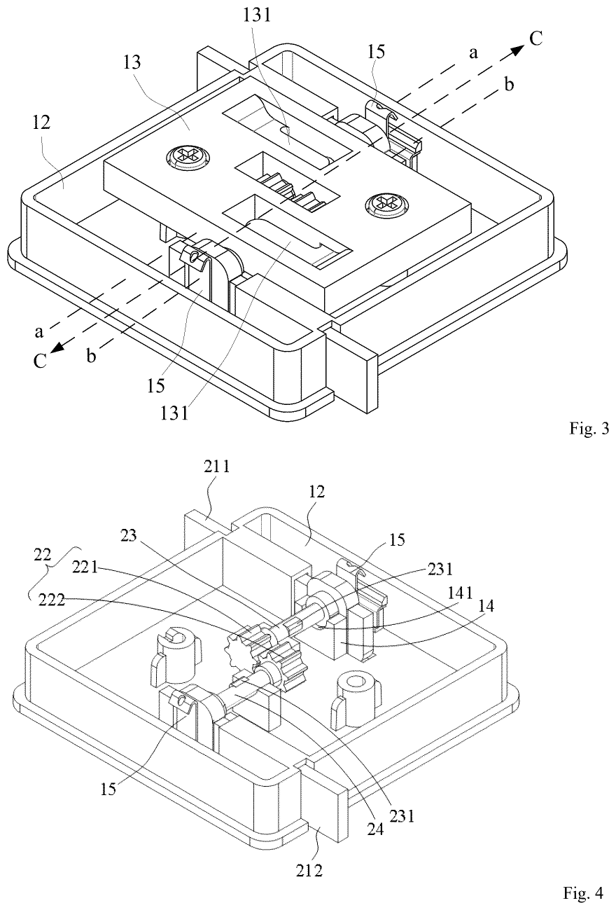

When the first pin 211 and the second pin 212 rotate between their respective storage positions and use positions relative to the main body 10, one of the first pin 211 and the second pin 212 can rotate clockwise, while the other of the first pin 211 and the second pin 212 rotates counterclockwise when viewed in a direction parallel to direction C in FIG. 3. Different from the related art, when the first pin 211 and the second pin 212 move from the use position to the storage position, the rotation directions thereof are opposite. In this case, when the main body 10 rotates in a preset direction, one of the first pin 211 and the second pin 212 can be switched from the use state to the storage state, and when the main body 10 rotates in a direction opposite to the preset direction, the other of the first pin 211 and the second pin 212 can be switched from the use state to the storage state. Regardless of the relative rotation of the main body 10 in either of the above two directions, one of the pins will remain in the use state. When the first pin 211 and the second pin 212 of the plug 1 are inserted and fixed into the socket, even if the main body 10 is stressed and tends to rotate relatively toward one of the above two directions, one of the pins will remain in the use state, which restricts the main body 10 from being stressed to rotate to a certain extent, thus improving a problem that when the plug 1 in the related art is inserted in the socket, the main body 10 easily moves relative to the pin assembly under the action of external force, resulting in the phenomenon of “kneeling pin.”

According to an example of the present disclosure, the rotation axes of the first pin 211 and the second pin 212 may be both parallel to the direction in which the first pin 211 and the second pin 212 are provided at intervals. For example, as shown by lines a and b in FIGS. 2 and 3, the line a is the rotation axis of the first pin 211, and the line b is the rotation axis of the second pin 212. The direction in which the first pin 211 and the second pin 212 are provided at intervals is an arrangement direction of the first pin 211 and the second pin 212 and can be shown as direction C in FIGS. 2 and 3, and the line a and the line b are parallel to the direction C.

According to an example of the present disclosure, the first pin 211 and the second pin 212 may be linked (e.g., coupled, connected). When one of the first pin 211 and the second pin 212 rotates relative to the main body 10, the other can be driven to rotate synchronously relative to the main body 10.

By this means, the first pin 211 and the second pin 212 can be simultaneously moved from their respective storage positions to their respective use positions, and can also be simultaneously moved from the use positions to the storage positions. In addition, as mentioned above, when the first pin 211 and the second pin 212 are inserted into the socket and the main body 10 rotates in any direction, one of the first pin 211 and the second pin 212 can be kept in the use position, while when the first pin 211 and the second pin 212 are linked and one of the first pin 211 and the second pin 212 is kept in the use position, the other of the first pin 211 and the second pin 212 is kept in the use position, making the plug 1 less prone to the phenomenon of “kneeling pin.”

Referring to FIGS. 3, 4, 5 and 6, according to an example of the present disclosure, the plug 1 may include a linkage mechanism 22 provided in the main body 10. The pin assembly 20 includes a first rotating shaft 23 and a second rotating shaft 24 in the main body 10. The first pin 211 and the first rotating shaft 23 are relatively fixed, so that the first pin 211 rotates around a rotating axis of the first rotating shaft 23 when rotating. The second pin 212 and the second rotating shaft 24 are relatively fixed, so that the second pin 212 rotates around a rotating axis of the second rotating shaft 24 when rotating. The first rotating shaft 23 and the second rotating shaft 24 are in transmission connection through the linkage mechanism 22, so that the first pin 211 and the second pin 212 can rotate synchronously.

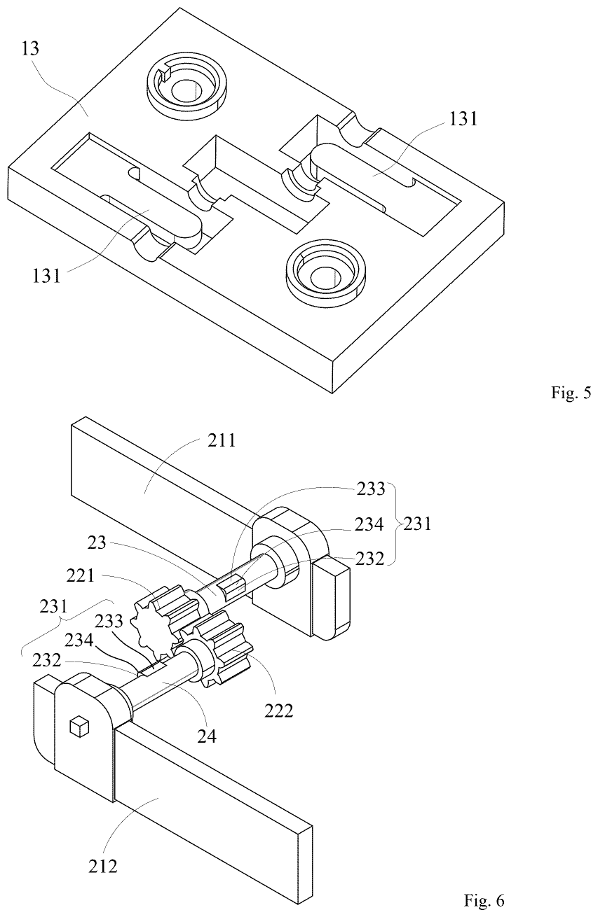

Referring to FIGS. 4 and 6, according to an example of the present disclosure, the linkage mechanism 22 may include a first gear 221 provided on the first rotating shaft 23 and a second gear 222 provided on the second rotating shaft 24, and the first gear 221 and the second gear 222 are engaged with each other, so that the first rotating shaft 23 and the second rotating shaft 24 can be in transmission connection. The first gear 221 can be integrally formed with the first rotating shaft 23, and the second gear 222 can be integrally formed with the second rotating shaft 24.

According to an example of the present disclosure, the main body 10 may further include a main housing 11 and a face housing 12. The main housing 11 is provided with an accommodating cavity 111 with an opening 112. The face housing 12 is connected to the main housing 11 and covers the opening 112. The first pin 211 and the second pin 212 correspond to each other in their respective storage positions and are at least partially stored in the face housing 12. The first pin 211 and the second pin 212 extend to a side the face housing 12 faces in their respective use positions. When the plug 1 of the present disclosure is applied to a charger, a circuit board may be provided inside the accommodating cavity 111.

Referring to FIGS. 1, 2 and 3, according to an example of the present disclosure, the main body 10 is provided with two storage grooves 120 which can extend in a first direction. The first pin 211 and the second pin 212 are at least partially stored in the storage grooves 120 respectively in the first direction when in the storage positions. The first pin 211 and the second pin 212 extend from a side of the main body 10 in a second direction perpendicular to the first direction when in the use positions. The first direction may be shown by arrow A in FIG. 1, and the second direction may be shown by arrow B in FIG. 1.

By this means, the first pin 211 and the second pin 212 can be moved into the storage grooves 120 for storage. Specifically, the two storage grooves 120 may be formed on the surface of the face housing 12.

According to an example of the present disclosure, the two storage grooves 120 further penetrate through the main body 10 in forward and reverse directions of the first direction, and the first pin 211 and the second pin 212 further extend from the main body 10 in the forward and reverse directions of the first direction when in the storage positions. Since a length of the storage groove 120 is not necessarily greater than lengths of the first pin 211 and the second pin 212, specifications of the main body 10 can be designed relatively freely.

Referring to FIGS. 3 and 4, according to an example of the present disclosure, the first rotating shaft 23 and the second rotating shaft 24 and the linkage mechanism 22 may be provided inside the accommodating cavity 111. The main body 10 may further include a pressing plate 13 which is provided inside the accommodating cavity to support the first rotating shaft 23 and the second rotating shaft 24. For example, the pressing plate 13 may be provided opposite to the face housing 12, and the first rotating shaft 23 and the second rotating shaft 24 are rotatably located between the pressing plate 13 and the face housing 12.

Referring to FIGS. 3 and 5, according to an example of the present disclosure, the pressing plate 13 is provided with two elastic arms 131. One end of each of the elastic arms 131 extends from the pressing plate 13, and the other end thereof is suspended. The two elastic arms 131 are configured to elastically press the first rotating shaft 23 and the second rotating shaft 24 respectively. By this means, the two elastic arms 131 can respectively abut against the first rotating shaft 23 and the second rotating shaft 24 to press them on the face housing 12. In addition, the two elastic arms 131 can be adaptively and elastically deformed to press the first rotating shaft 23 and the second rotating shaft 24 on the face housing 12 reliably and stably.

Referring to FIGS. 4 and 6, according to an example of the present disclosure, peripheral surfaces of the first rotating shaft 23 and the second rotating shaft 24 are provided with arc-shaped protrusions 231. The two elastic arms 131 elastically press the two arc-shaped protrusions 231 respectively. Each of the arc-shaped protrusions 231 has a first limiting surface 232, a second limiting surface 233 and a transitional curved surface 234 connecting the first limiting surface 232 and the second limiting surface 233.

When the first pin 211 and the second pin 212 are in the use positions, the two elastic arms 131 elastically press the first limiting surfaces 232 of the two arc-shaped protrusions 231 respectively, and when the first pin 211 and the second pin 212 are in the storage positions, the two elastic arms 131 elastically press the second limiting surfaces 233 of the two arc-shaped protrusions 231 respectively. During the rotation of the first pin 211 and the second pin 212 between the respective storage positions and use positions, the two elastic arms 131 elastically press the transitional curved surfaces 234 of the two arc-shaped protrusions 231, respectively, and the two elastic arms 131 deviate away from the first rotating shaft 23 and the second rotating shaft 24 when pressing the respective first limiting surface 232 and the second limiting surface 233.

A contact area between the elastic arm 131 and the first limiting surface 232 when the elastic arm 131 abuts against the first limiting surface 232 may be larger than a contact area between the elastic arm 131 and the transitional curved surface 234 when the elastic arm 131 abuts against the transitional curved surface 234, or a contact area between the elastic arm 131 and the second limiting surface 233 may be larger than that between the elastic arm 131 and the transitional curved surface 234 when the elastic arm 131 abuts against the second limiting surface 233 may be larger than a contact area between the elastic arm 131 and the transitional curved surface 234 when the elastic arm 131 abuts against the transitional curved surface 234, so that the elastic arm 131 can more stably abut against the first limiting surface 232 or the second limiting surface 233, and thus the first pin 211 and the second pin 212 can be stably kept in the use positions or the storage positions without easily shaking.

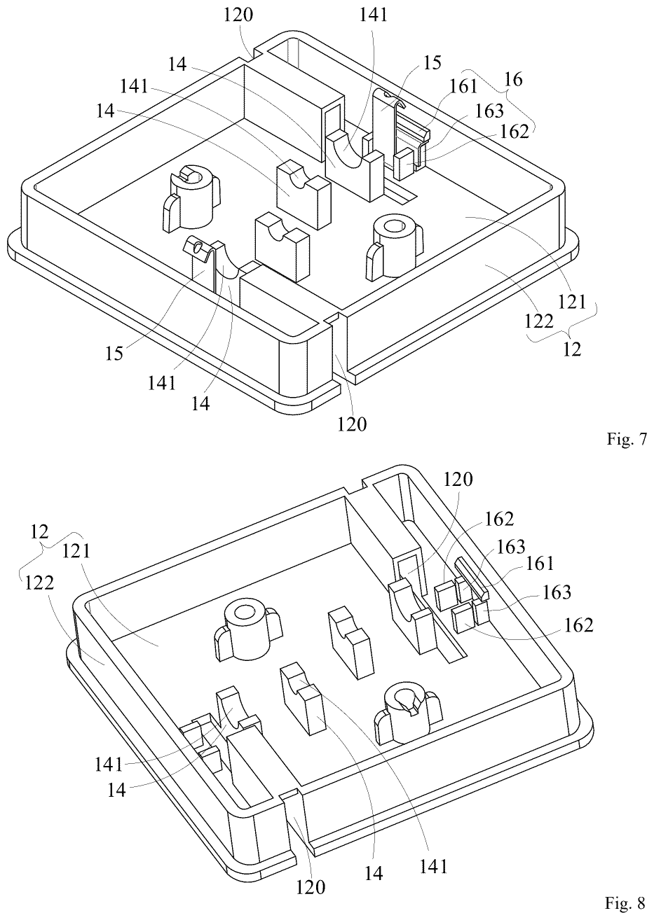

Referring to FIGS. 7 and 8, according to an example of the present disclosure, the face housing 12 is provided with a plurality of rotating shaft supports 14. The first rotating shaft 23 and the second rotating shaft 24 are respectively provided on a plurality of the rotating shaft supports 14, each of the rotating shaft supports 14 is provided with a groove 141, and the first rotating shaft 23 and the second rotating shaft 24 are rotatably provided in the groove 141. By this means, the rotating shaft support 14 can limit shaking of the first rotating shaft 23 and the second rotating shaft 24 to a certain extent, so as to improve stability of assembly of the first rotating shaft 23 and the second rotating shaft 24.

According to an example of the present disclosure, the number of the rotating shaft supports 14 may be four, and the first rotating shaft 23 and the second rotating shaft 24 are respectively supported by two of the rotating shaft supports 14. In this case, the two rotating shaft supports 14 can restrict rotation of the first rotating shaft 23 and the second rotating shaft 24 around axes other than the axes of the first rotating shaft 23 and the second rotating shaft 24 to a certain extent, thereby improving the stability of assembly of the first rotating shaft 23 and the second rotating shaft 24.

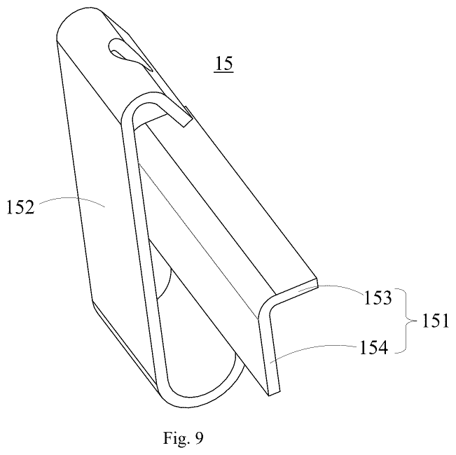

Referring to FIG. 7 and FIG. 9, according to an example of the present disclosure, the main body 10 further includes two conductive members 15 (e.g., metal plate, metal sheet) in the face housing 12, and the two conductive members 15 are electrically connected with the first pin 211 and the second pin 212 respectively. One of the conductive members 15 is electrically connected with the first pin 211, and the other of the conductive members 15 is electrically connected with the second pin 212. Taking the plug 1 used for a charger as an example, the conductive members 15 may be used for connecting the circuit board with the first pin 211 and the second pin 212. Taking the plug 1 used for a power extension cord as an example, the conductive members 15 may be used for connecting the power extension cord with the first pin 211 and the second pin 212.

According to an example of the present disclosure, two fixing members 16 are provided in the face housing 12. One of the conductive members 15 is provided at a position of one of the fixing members 16 and abuts against the corresponding first pin 211, the other of the conductive members 15 is provided, for example, at a position of the other of the fixing members 16 and abuts against the corresponding second pin 212. In this case, the two conductive members 15 can be electrically connected with the first pin 211 and the second pin 212 respectively by abutment. In addition, compared with wire connection, the two conductive members 15 respectively abutting against the first pin 211 and the second pin 212 can avoid the risk of life reduction caused by repeated bending of the wire to some extent.

Referring to FIG. 9, according to an example of the present disclosure, the conductive member 15 includes a fixing portion 151 and a connecting arm 152. One end of the connecting arm 152 is connected with a first end of the fixing portion 151, and the other end thereof is suspended and extends toward a second end of the fixing portion 151 to elastically abut against the first pin 211 or the second pin 212. In this case, the connecting arm 152 can have certain elasticity to keep good contact with the first pin 211 or the second pin 212, so as to avoid the risk that the electrical connection between the conductive member 15 and the first pin 211 or the second pin 212 is disconnected during the rotation.

Referring to FIG. 8, according to an example of the present disclosure, the fixing member 16 may include a first stop 161, a second stop 162 and a third stop 163. The fixing portion 151 includes a first part 153 and a second part 154 which are bent. The first part 153 may be provided between the first stop 161 and the third stop 163. The second part 154 is provided between the second stop 162 and the third stop 163.

The face housing 12 may include a bottom wall 121 and a side wall 122 surrounding the bottom wall 121. The first stop 161 may be provided on the side wall 122. The second stop 162 may be provided on the bottom wall 121. The third stop 163 may be provided at a junction of the side wall 122 and the bottom wall 121. In this case, the first stop 161 and the third stop 163 cooperate to restrict the first part 153 from shaking in an extension direction of the side wall 122, and the second stop 162 and the third stop 163 cooperate to restrict the second part 154 from shaking in one extension direction of the bottom wall 121, thereby improving stability of assembly of the conductive member 15.

According to an example of the present disclosure, the number of the third stops 163 is two, and the two third stops 163 are provided opposite to form an accommodating space for accommodating the connecting arm 152. In this case, the third stop 163 can restrict the connecting arm 152 of the conductive member 15 from shaking in the other extension direction of the bottom wall 121, thereby improving the stability of assembly of the conductive member 15.

The above are only some examples of the present disclosure and do not limit the scope of the disclosure. Transformation of an equivalent structure or process made with the contents of the description and drawings of the present disclosure is directly or indirectly used in other related technical fields, and should be included in the protection scope of the present disclosure.

What is claimed is:

1. A plug comprising:
a main body;
a first pin; and
a second pin, wherein:
each of the first pin and the second pin is rotatably coupled to the main body between a respective storage position and a respective use position relative to the main body,
rotation axes of the first pin and the second pin are parallel to each other, and
a rotation direction of the first pin is opposite to a rotation direction of the second pin.

2. The plug of claim 1, wherein:
the first pin and the second pin are connected, and
the first pin and the second pin are configured to rotate from the respective storage position to the respective use position simultaneously.

3. The plug of claim 1, wherein:
the main body comprises a linkage mechanism,
the main body comprises a first rotating shaft coupled to the first pin and a second rotating shaft coupled to the second pin,
the first pin is configured to rotate around a rotating axis of the first rotating shaft,
the second pin is configured to rotate around a rotating axis of the second rotating shaft and
the first rotating shaft and the second rotating shaft are in transmission connection through the linkage mechanism.

4. The plug of claim 3, wherein:
the linkage mechanism comprises a first gear coupled to the first rotating shaft and a second gear coupled to the second rotating shaft, and
the first gear and the second gear are engaged with each other.

5. The plug of claim 4, wherein the first gear is integrally formed with the first rotating shaft, and the second gear is integrally formed with the second rotating shaft.

6. The plug of claim 4, wherein:
the main body further comprises a main housing and a face housing,
the main housing comprises an accommodating cavity with an opening, and
the face housing is connected to the main housing and covers the opening,
the first pin and the second pin are at least partially stored in the face housing, and
the first pin and the second pin extend toward a side the face housing in the respective use positions.

7. The plug of claim 6, wherein:
the main body further comprises a pressing plate inside the accommodating cavity to support the first rotating shaft and the second rotating shaft,
the first rotating shaft, the second rotating shaft, and the linkage mechanism are provided inside the accommodating cavity, and
the first rotating shaft and the second rotating shaft are located between the pressing plate and the face housing.

8. The plug of claim 7, wherein:
the pressing plate comprises two elastic arms,
a first end of each of the two elastic arms extends from the pressing plate, and a second end of each of the elastic arms is suspended, and
the two elastic arms are configured to elastically press the first rotating shaft and the second rotating shaft respectively.

9. The plug of claim 8, wherein:
peripheral surfaces of the first rotating shaft and the second rotating shaft are provided with arc-shaped protrusions,
each of the arc-shaped protrusions has a first limiting surface, a second limiting surface, and a transitional curved surface connecting the first limiting surface and the second limiting surface,
when the first pin and the second pin are in the use positions, the two elastic arms are configured to press the first limiting surfaces of the arc-shaped protrusions respectively,
when the first pin and the second pin are in the storage positions, the two elastic arms are configured to press the second limiting surfaces of the arc-shaped protrusions respectively, and
during the rotation of the first pin and the second pin between the respective storage positions and use positions, the two elastic arms are configured to press the transitional curved surfaces of the arc-shaped protrusions respectively.

10. The plug of claim 9, wherein
a contact area between one of the two elastic arms and the first limiting surface when the one of the two elastic arms abuts against the first limiting surface is larger than a contact area between the one of the two elastic arms and the transitional curved surface when the one of the two elastic arms abuts against the transitional curved surface; or
a contact area between the one of the two elastic arms and the second limiting surface when the elastic arm abuts against the second limiting surface is larger than a contact area between the one of the two elastic arms and the transitional curved surface when the one of the two elastic arms abuts against the transitional curved surface.

11. The plug of claim 1, wherein:
the main body further comprises two conductive members,
the two conductive members are electrically connected with the first pin and the second pin respectively,
one of the conductive members is electrically connected with the first pin, and
the other of the conductive members is electrically connected with the second pin.

12. The plug of claim 11, wherein the two conductive members are configured to abut against the first pin and the second pin respectively.

13. The plug of claim 11, wherein:
one of the two conductive member comprises a fixing portion and a connecting arm,
a first end of the one of the two connecting arm is connected with a first end of the fixing portion, and
a second end of the one of the two connecting arm is suspended and extends toward a second end of the fixing portion to abut against the first pin or the second pin.

14. The plug of claim 13, wherein:
the main body comprises a bottom wall and a side wall surrounding the bottom wall,
the main body comprises a fixing member,
the fixing member comprises a first stop provided on the side wall, a second stop on the bottom wall, and a third stop provided at a junction of the side wall and the bottom wall,
the fixing portion comprises a first bent part and a second bent part, and
the first bent part is provided between the first stop and the third stop, and the second bent part is provided between the second stop and the third stop.

15. The plug of claim 1, wherein when the first pin and the second pin are both located at the respective storage positions, the first pin and the second pin are partially folded in the main body.

16. The plug of claim 1, wherein:
the first pin and the second pin are configured to simultaneously move from the respective storage positions to the respective use positions, and are configured to simultaneously move from the respective use positions to the respective storage positions.

17. The plug of claim 6, wherein:
the face housing is provided with a plurality of rotating shaft supports,
the first rotating shaft and the second rotating shaft are respectively provided on a plurality of the rotating shaft supports,
each of the rotating shaft supports is provided with a groove, and the first rotating shaft and the second rotating shaft are rotatably provided in the groove.

18. The plug of claim 1, wherein:
the main body is provided with two storage grooves extending in a first direction,
the first pin and the second pin are at least partially stored in the storage grooves respectively in the first direction when in the storage positions, and
the first pin and the second pin are configured to extend from a side of the main body in a second direction perpendicular to the first direction when in the use positions.

19. A plug comprising:
a main body; and
a plurality of pins coupled to the main body, wherein:
each of the plurality of pins is configured to rotate from a storage position to a use position, and
a rotation direction of a first pin of the plurality of pins from the storage position to the use position is opposite to a rotation direction of a second pin of the plurality of pins from the storage position to the use position.

20. The plug of claim 19, wherein:
the main body comprises a first rotating shaft coupled to the first pin and a second rotating shaft coupled to the second pin,
the first pin is configured to rotate around a rotating axis of the first rotating shaft, and
the second pin is configured to rotate around a rotating axis of the second rotating shaft.
